(19) United States
(12) Patent Application Publication
(10) Pub. No.: US 2010/0012197 A1
(43) Pub. Date: Jan. 21, 2010

(54) AUTOMATIC WATER DIVERTER

(75) Inventor: Zhi-Bin LIU, Guangdong Province (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP.

(21) Appl. No.: 12/173,616

(22) Filed: Jul. 15, 2008

(51) Int. Cl. F16K 11/048

(52) U.S. Cl. 137/119.04; 137/540

(57) ABSTRACT

An automatic water diverter is provided, in which a flange is disposed on a passage of a valve seat, so as to form a through hole. In addition, an upper and a lower side of the passage are respectively connected to an upper and a lower outlet pipe, and two sides of the passage are respectively connected to an inlet pipe. A diverting assembly is disposed within the passage, and a seal is fixed on a diverting rod of the diverting assembly, so as to seal the through hole. Moreover, a check valve is disposed on a lower side of the diverting rod. A sliding sleeve is disposed between the tapered seal and the check valve, and has a via hole corresponding to the inlet pipe. The sliding sleeve has a spring disposed therein, and two heads of the spring are pressed against the flange and the sliding sleeve respectively.

### BACKGROUND OF THE INVENTION

1. Field of the Invention

The present invention relates to an automatic water diverter for a bath faucet, and more particularly to a water diverter, which is capable of automatically changing a switching position through utilizing the resistance of a water passage, and alleviating switching noises of the faucet and satisfying the flow standard of a spray member by disposing a diverting assembly at an upstream of a check valve.

2. Related Art

Generally, a conventional diverter valve for a bath faucet is configured with a structure as disclosed in US Patent Publication No. U.S. Pat. No. 5,752,541, which provides a spray member function. The diverter valve includes a seal to engage a valve housing and prevent back siphonage, and further includes a piston head and a valve seat to provide secondary against back flow.

When the spray member is closed, the seal of the diverter valve (first head) is forced to move away from a sealing position and allow the fluid flow to the spout. When the spray member is open, the fluid pressure can cause the diverter valve to close off fluid from entering to the spout, and allow fluid flow past the piston (second head) into the spray member.

Although the conventional diverter valve provides a water diverting function, the structure is then used and practically tested, it results that no fluid flows out from the spray member when the spray member is open when an inlet fluid pressure is a low pressure (20 PSI) with no water economizer added to the spray member, due to a locking force at one head of the seal is smaller than that of one head of the piston, If a water economizer is further added, the situation is much worse.

When the inlet fluid pressure is a high pressure (80-125 PSI) with no water economizer added to the spray member, the outlet pressure for the spray member is 80-125 PSI. However, switching the diverter valve may result in a water hammer effect to force the spray member generate vibrations and produce noises, and the outlet flow is then larger than a standard value of 9.5 L/M. If a water economizer was added to the spray member, the water economizer produces a blocking effect, therefore, the pressure within an inner cavity of the diverter valve is increased and forces the piston to open. As a result, the fluid flows out from both the spray member and the other outlet, and it is impossible to achieve the function of water diverting.

Therefore, it has become a technical problem to be solved by the inventor of the present invention how to provide an automatic water diverter capable of automatically diverting the water, reducing the vibrations and noises generated during switching, and satisfying the standard of the outlet flow.

### SUMMARY OF THE INVENTION

In view of the above problem, the present invention is directed to a water diverter, which is capable of automatically changing the resistance of the water passage through utilizing the fluid pressure, thereby alleviating the vibrations and noises generated during switching and satisfying the flow standard.

In order to achieve the above objective, the present invention provides an automatic water diverter, which includes: a valve seat, a diverting assembly, and a spring. The valve seat has a passage disposed in the center thereof, which axially penetrates therethrough. A flange protruding inwards is annularly disposed on an inner peripheral surface of a top side of the passage, so as to form a through hole. An upper side of the valve seat is connected to an upper outlet pipe, a lower side thereof is connected to a lower outlet pipe, and the valve seat is connected to at least one inlet pipe. The diverting assembly is sleeved within the valve seat, and includes: a seal, a diverting rod, a sliding sleeve, and a check valve. The diverting rod has a suitable length and is sleeved in the passage in a manner of moving up and down. An upper side of the diverting rod is fixed to the seal, and the check valve is disposed at a lower side of the diverting rod and is made of a compressible elastic material. The sliding sleeve is sleeved on the diverting rod and disposed between the tapered seal and the check valve. The sliding sleeve has a via hole corresponding to the inlet pipe, which is provided for the fluid to pass through. The spring is disposed within the sliding sleeve, one head of the spring is pressed against a bottom surface of the flange, and the other head is pressed against the sliding sleeve.

A water limiting element is further connected to a bottom part of the sliding sleeve, so as to control the fluid flow.

Therefore, the automatic water diverter of the present invention uses the fluid pressure effect to force the diverting rod of the present invention move up and down to automatically control the diverting direction and reduce the vibrations and noises generated during the movement. Meanwhile, through the mutual motions between elements, the water limiting function may be achieved, so as to satisfy the flow standard of the spray member.

In order to the make aforementioned and other objects, features, and advantages of the present invention comprehensible, the embodiment accompanied with figures is described in detail below.

Definitely, the present invention allows some variations on certain parts or arrangement of the parts, but the embodiment selected in the present invention is illustrated in detail in the specification, and the construction thereof is shown in the accompanying drawings.

### BRIEF DESCRIPTION OF THE DRAWINGS

The present invention will become more fully understood from the detailed description given herein below for illustration only, and thus is not limitative of the present invention, and wherein:

FIG. 1 is a cross-sectional view of an embodiment of the present invention;

FIG. 1A is a top view of a stopper and an O-ring disposed on a sliding sleeve according to an embodiment of the present invention;

FIG. 2 is a schematic view of the present invention being assembled on a bath faucet;

FIG. 3 is a first schematic view of a using state of the present invention; and

FIG. 4 is a second schematic view of a using state of the present invention.

### DETAILED DESCRIPTION OF THE INVENTION

As for the technical means adopted in the present invention to achieve the above objective, a detailed illustration is given below through the embodiment and accompanying drawings.

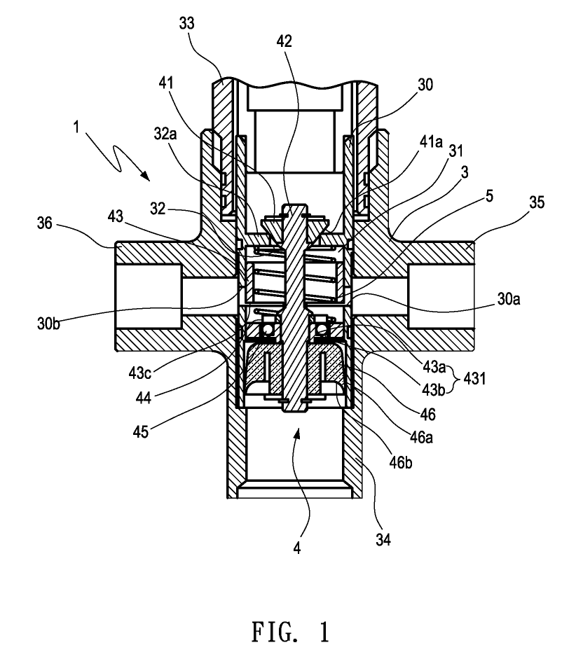

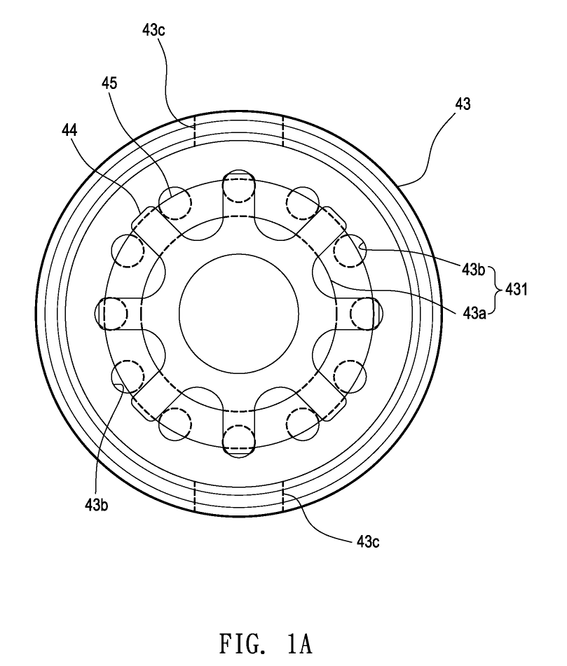

FIG. 1 is a cross-sectional view of an embodiment of the present invention. Referring to FIG. 1, an automatic water diverter 1 of the present invention mainly includes a valve seat 3, a diverting assembly 4, and a spring 5.

The valve seat 3 has a bushing 30 sleeved therein, and the bushing 30 has a passage 31. A flange 32a protruding inwards is annularly disposed on an inner peripheral surface at a middle section of the passage 31, so as to form a through hole 32 that may be tapered (not shown), but it is not limited herein. An upper side of the valve seat 3 is connected to an upper outlet pipe 33, a lower side thereof is connected to a lower outlet pipe 34, and two sides are further respectively connected to a cold water inlet pipe 35 and a hot water inlet pipe 36. The bushing 30 has inlet holes 30a and 30b respectively corresponding to the cold water inlet pipe 35 and the hot water inlet pipe 36, which are provided for the fluid to flow therein.

The diverting assembly 4 is sleeved within the valve seat 3. Particularly, the diverting assembly 4 is disposed in the passage 31 of the bushing 30 and includes: a tapered seal 41, a diverting rod 42, a sliding sleeve 43, a stopper 44, an O-ring 45, and a check valve 46. The diverting rod 42 has a suitable length and is sleeved in the passage 31 in a manner of moving up and down. An upper side of the diverting rod 42 is protruded from the through hole 32 and is fixed with the tapered seal 41. The tapered seal 41 has a tapered surface 41a corresponding to the through hole 32. A diameter of the through hole is between a minimum diameter and a maximum diameter of the tapered seal 41, so that the tapered seal 41 can partially pass through the through hole 32 and sleeve with the through hole 32 in order to seal the fluid.

The check valve 46 is disposed at a lower side of the diverting rod 42 (i.e., the head close to the lower outlet pipe), and is made of a compressible and elastic material (e.g., rubber), which cross-section is disk-shaped and an inner diameter is slightly smaller than that of the passage 31. The check valve 46 has a lip edge 46a at a periphery thereof, and the lip edge 46 is provided with a tapered space 46b increasingly expanding downwards disposed at an inner side thereof. The lip edge 46a has a suitable thickness and desirable flexibility, such that the lip edge 46a may expand outwards or shrink inwards by a fluid pressure effect.

The sliding sleeve 43 is sleeved on the diverting rod 42 and disposed between the tapered seal 41 and the check valve 46. Two sides of the sliding sleeve 43 respectively have a via hole 43c, and each via hole 43c is disposed corresponding to the inlet holes 30a and 30b, which is provided for the fluid to pass therethrough.

FIG. 1A is a top view of a stopper and an O-ring disposed on a sliding sleeve according to an embodiment of the present invention. Referring to FIG. 1A, a water limiting element 431 is connected to a bottom part of the sliding sleeve 4, and has an annular slot 43a. The annular slot 43a has several water limiting holes 43b disposed thereon, which are equidistantly spaced apart from each other. The water limiting holes 43b are disposed surrounding the inner diameter of the annular slot 43a, and a diameter of the water limiting holes 43b is slightly larger than a width of the annular slot 43a. The O-ring 45 is embedded in the annular slot 43a, and the diameter of the O-ring 45 is approximately the same as the width of the annular slot 43a. As the diameter of the water limiting holes 43b is slightly larger than the width of the annular slot 43a, the water limiting holes 43b still have some space for the fluid to pass therethrough when the O-ring 45 is embedded in the annular slot 43a, thereby controlling the fluid flow to satisfy the flow standard. The stopper 44 is disposed on the annular slot 43a, so as to firmly press the O-ring 45.

The spring 5 is disposed within the sliding sleeve 43, one head of the spring 5 is pressed against the bottom surface of the flange 32a, and the other head thereof is pressed against the stopper 44 or merely pressed against the bottom part of the sliding sleeve 43. The diverting rod 42 sequentially passes through the tapered seal 41, the through hole 32, the spring 5, the sliding sleeve 43, and the check valve 46, and the elements are pressed against each other, such that the diverting rod 42 is maintained in the center position.

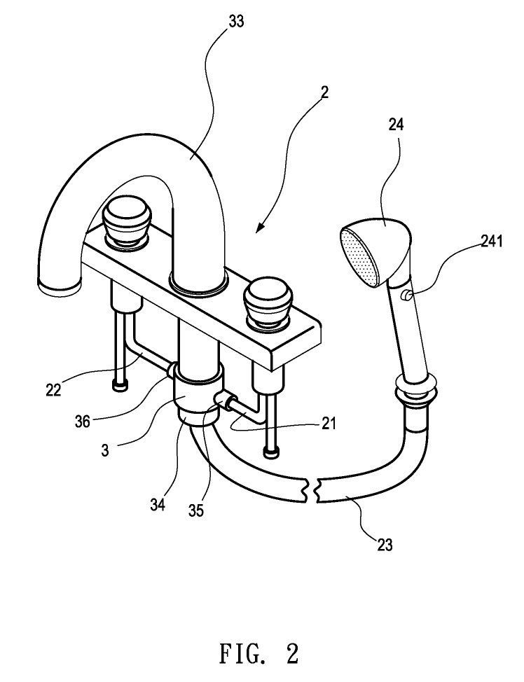

FIG. 2 is a schematic view of the present invention being assembled on a bath faucet. Referring to FIG. 2, a cold water pipe 21 and a hot water pipe 22 of a bath faucet assembly 2 are respectively connected to the cold water inlet pipe 35 and the hot water inlet pipe 36, and the lower outlet pipe 34 is connected to a spray member 24 through a hose 23, and the spray member 24 has a switch 241 to control the spray member 24 to be open or closed.

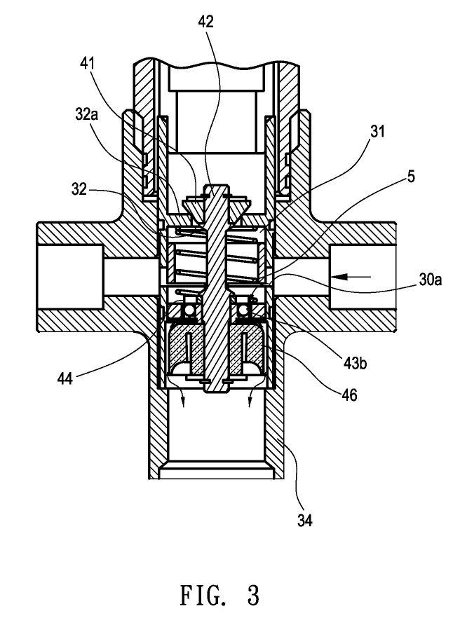

FIG. 3 is a first schematic view of a using state of the present invention. Referring to FIG. 3, when the switch of the spray member is turned on, the fluid (as indicated by the arrow) flows to the passage 31 via the inlet hole 30a. The spring 5 is respectively pressed against the flange 32a and the stopper 44, and the tapered seal 41 seals the through hole 32, so that the fluid flows downwards. Furthermore, the check valve 46 is made of a compressible elastic material (e.g., rubber), and under the fluid pressure generated by the fluid, the check valve 46 is forced to shrink inwards for the fluid to pass through, and then the fluid flows to the spray member via the lower outlet pipe 34. Meanwhile, the fluid may also pass through the water limiting hole 43b, so as to satisfy the flow standard.

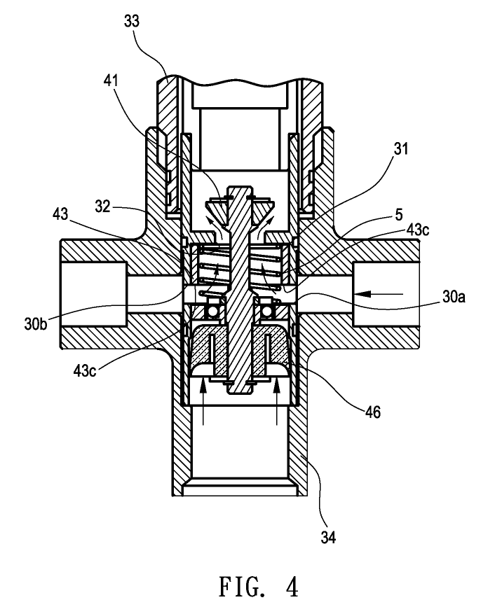

FIG. 4 is a second schematic view of a using state of the present invention. Referring to FIG. 4, when the switch of the spray member is turned off, the fluid fills up the lower outlet pipe 34, which forces the check valve 46 to expand outwards, so as to block the upward fluid pressure. Then, the check valve 46 together with the entire diverting assembly is pushed upwards under the fluid pressure. Meanwhile, as the fluid at the lower side of the passage 31 has been blocked by the check valve 46, the fluid pressure only produces an upward force. On the other hand, the sliding sleeve 43 is disposed between the tapered seal 41 and the check valve 46 through the spring 5, and the sliding sleeve 43 and the tapered seal 41 are made to move upwards to be away from the through hole 32, through utilizing the upward fluid pressure force and the downward elastic force of the spring 5. At this time, the flow path between each via hole 43c and each of the inlet holes 30a and 30b may be enlarged, so that the fluid flows to the upper outlet pipe 33 via the through hole 32, and the vibrations generated during switching are avoided, thereby reducing the noises.

Therefore, with the above structure, through turning on or off the switch of the spray member and utilizing the fluid pressure, the diverting rod of the present invention can be forced to move up and down to automatically control the diverting direction, thereby reducing the vibrations and noises generated during movement. Meanwhile, through the mutual motions between elements, the water limiting function may be achieved, so as to satisfy the flow standard of the spray member.

In addition, the sliding sleeve 43 is configured in a sliding manner, so that the via hole 43c and the inlet holes 30a and 30b may be disposed in a misalignment manner. Therefore, as the sliding sleeve 43 moves to another position, the size of the flow path formed between the via hole 43c and each of the inlet holes 30a and 30b may be changed accordingly. That is, when the tapered seal 41 seals the through hole 32, and the fluid is forced to flow downwards through the check valve 46, a smaller flow path is formed between the via hole 43c and the inlet holes 30a and 30b (the state as shown in FIG. 3). When the diverting rod 42 moves upwards, the tapered seal 41 moves away from the through hole 32, and the fluid is forced to flow upwards through the through hole 32, a larger flow path is formed between the via hole 43c and the inlet holes 30a and 30b (the state as shown in FIG. 4). Therefore, through such a misalignment configuration, the effects of water saving and satisfying the flow standard can be achieved.

Furthermore, under the common requirement of a large outlet flow at the outlet (larger than 8 GPM under a pressure of 40 PSI), the outlet flow of the spray member must be smaller than 9.5 L/M. For the structure of the present invention, when the cold water pipe 21 or/and the hot water pipe 22 has a low pressure (20 PSI) therein, the fluid pressure in the passage 31 is also the low pressure (20 PSI), while the locking force of the tapered seal 41 can be improved through the spring 5, such that it can also achieve the diverting function. When the cold water pipe 21 or/and the hot water pipe 22 has a high pressure (80-125 PSI) therein, the fluid pressure in the passage 31 is smaller than 80 PSI, so as to lower the pressure in the cold water pipe 21 or/and the hot water pipe 22, thereby reducing the vibrations and impacting noises caused by the water hammer effect. That is, the sliding sleeve 43 is provided for attenuating the fluid supply pressure force. Therefore, no matter the diverting assembly 4 moves upwards or downwards, the force applied thereon is smaller than that of the conventional structure, so the vibrations and impacting noises generated by the water diverter 1 are greatly alleviated.

Therefore, the automatic water diverter of the present invention can surely achieve the objective of the present invention.

The disclosure of the embodiments is intended to illustrate the present invention, but not to limit the scope of the present invention, so the variation of cited values or replacement of equivalent elements still falls within the scope of the present invention.

Through the above detailed descriptions, it is apparent for those skilled in the art that the present invention surely achieves the above objectives, which conforms to the provisions of the patent law, so as to apply for the patent application.

What is claimed is:

1. An automatic water diverter, comprising:
a valve seat, having a passage penetrating therethrough, wherein a flange protruding inwards is disposed on an inner peripheral surface of the passage so as to form a through hole, an upper side of the valve seat is connected to an upper outlet pipe, a lower side thereof is connected to a lower outlet pipe, and the valve seat is connected to at least one inlet pipe;
a diverting assembly, sleeved within the valve seat, comprising: a seal, a diverting rod, a sliding sleeve, and a check valve, wherein the seal is used to seal the through hole of the valve seat; the diverting rod has a suitable length and is sleeved into the passage in a manner of moving up and down, an upper side of the diverting rod is fixed to the seal, the check valve is disposed at a lower side of the diverting rod to prevent a fluid in the lower outlet pipe flowing back to the passage; and the sliding sleeve is sleeved on the diverting rod and disposed between the seal and the check valve, and the sliding sleeve has a via hole corresponding to the inlet pipe, for the fluid to pass through; and
an elastic element, disposed within the sliding sleeve, wherein one head of the elastic element is pressed against a bottom surface of the flange, and an other head is pressed against the sliding sleeve.

2. The automatic water diverter according to claim 1, wherein the diverting assembly further has a water limiting element disposed at a bottom part of the sliding sleeve.

3. The automatic water diverter according to claim 2, wherein the water limiting element has an annular slot with several water limiting holes equidistantly spaced apart thereon, each water limiting hole is disposed surrounding the annular slot, and a diameter of each water limiting hole is slightly larger than a width of the annular slot.

4. The automatic water diverter according to claim 3, wherein the diverting assembly further has a stopper and an O-ring, the O-ring is embedded in the annular slot, and the stopper is disposed on the annular slot to press firmly the O-ring.

5. The automatic water diverter according to claim 4, wherein a diameter of the O-ring matches with the width of the annular slot.

6. The automatic water diverter according to claim 5, wherein the other head of the elastic element is pressed against the stopper.

7. The automatic water diverter according to claim 6, wherein a diameter of the through hole is between a minimum diameter and a maximum diameter of the seal, so that the tapered seal can partially pass through the through hole and sleeve with the through hole in order to seal the fluid.

8. The automatic water diverter according to claim 2, wherein a bushing is further sleeved in the valve seat, the passage and the flange of the valve seat are both formed within the bushing, and the bushing has an inlet hole respectively corresponding to each inlet pipe and is disposed in a misalignment manner, so that a size of a flow path formed between the via hole and each inlet hole is changed as the sliding sleeve moves to another position.

9. The automatic water diverter according to claim 1, wherein the check valve has a lip edge at a periphery thereof, and the lip edge is provided with a tapered space increasingly expanding downwards on an inner side thereof, and provided with a triangular cross-section and a chamfer with a suitable slope on an inner peripheral surface thereof, and the lip edge has a suitable thickness and desirable flexibility to expand outwards or shrink inwards by a fluid pressure effect.

10. The automatic water diverter according to claim 1, wherein the seal is tapered.

11. The automatic water diverter according to claim 1, wherein the check valve is made of a compressible elastic material.

12. The automatic water diverter according to claim 11, wherein the check valve is made of a rubber material.

13. The automatic water diverter according to claim 1, wherein the elastic element is a compression spring.
